(19) United States
(12) Patent Application Publication
(10) Pub. No.: US 2016/0157206 A1
(43) Pub. Date: Jun. 2, 2016

(54) INFORMATION NOTIFICATION METHOD AND INSTANT NOTIFICATION DEVICE

(71) Applicants: Inventec (Pudong) Technology Corporation, Shanghai (CN); Inventec Corporation, Taipei (TW)

(72) Inventor: Meng Sun, Shanghai (CN)

(21) Appl. No.: 14/952,371

(22) Filed: Nov. 25, 2015

(30) Foreign Application Priority Data
Dec. 2, 2014 (CN) 201410720242.8

(51) Int. Cl. H04W 68/00; H04L 12/58

(52) U.S. Cl. CPC H04W 68/005; H04L 51/046; H04L 51/38

(57) ABSTRACT

The present disclosure relates to an information notification method and an instant notification device. The method includes: receiving, by the instant notification device, an instant message sent by a locally registered terminal device through a wireless network and sending an instant message notification according to the instant message; and interacting, by an integrated multiservice gateway of the instant notification device, information with a plurality of electronic terminal devices through the wireless network within a small area range, so that a user may receive the instant message in time, such as a short message, a phone call, instant messaging information, etc.

### TECHNICAL FIELD

The present disclosure relates to information technology, and particularly, to an information notification method and an instant notification device.

### BACKGROUND

In modern life, people interact and communicate with each other by sending short messages, making phone calls and using Instant Messaging (IM), such as QQ, MSN, WeChat, microblog, etc. But at the same time, people will encounter some cases such as: if mobile phones are placed in handbags, under pillows or in pockets, calls, short messages, WeChat or other information cannot be found by users in time. When opening IMs or email client terminals on computers, people cannot see relevant instant information in time on account of being away from the computers. Among the information failed to be seen by the users in time, some may be very important to them, and some may bring unnecessary troubles or losses to the users due to late notices from the users.

### SUMMARY

To this end, the present disclosure provides an information notification method and an instant notification device.

According to a first aspect, embodiments of the present disclosure provide an information notification method, including:

interacting, by an integrated multiservice gateway of an instant notification device, information with a plurality of electronic terminal devices through a wireless network within a small area range;

receiving, by the instant notification device, an instant message sent by a locally registered terminal device through the wireless network; and

sending, by the instant notification device, an instant message notification according to the instant message.

According to a second aspect, the embodiments of the present disclosure provide an instant notification device, including:

an integrated multiservice gateway, configured to interact information with a plurality of electronic terminal devices through a wireless network within a small area range;

a receiving module, configured to receive an instant message sent by a locally registered terminal device through the wireless network; and

a processing module, configured to send an instant message notification according to the instant message.

According to the information notification method and the instant notification device provided by the present disclosure, interacting, by the integrated multiservice gateway of the instant notification device, information with the plurality of electronic terminal devices through the wireless network within the small area range, receiving the instant message sent by the locally registered terminal device through the wireless network and sending the instant message notification according to the instant message enables users to receive instant messages in time, such as short messages, phone calls, instant messaging information, etc.

### BRIEF DESCRIPTION OF DRAWINGS

FIG. 1 is a flowchart of an information notification method according to an embodiment of the present disclosure;

FIG. 2 is a network architecture diagram of an instant notification system according to the present disclosure;

FIG. 3 is a flowchart of an information notification method according to another embodiment of the present disclosure;

FIG. 4 is a flowchart of a network connection method of an instant notification system according to the present disclosure;

FIG. 5 is another flowchart of a network connection method of an instant notification system according to the present disclosure;

FIG. 6 is a flowchart of a method for registering a terminal device to an instant notification device according to the present disclosure;

FIG. 7 is a framework flowchart of an information notification method according to the present disclosure;

FIG. 8 is another framework flowchart of an information notification method according to the present disclosure;

FIG. 9 is a schematic diagram of a structure of an instant notification device according to an embodiment of the present disclosure; and

FIG. 10 is a schematic diagram of a structure of an instant notification device according to another embodiment of the present disclosure.

### DETAILED DESCRIPTION OF EMBODIMENTS

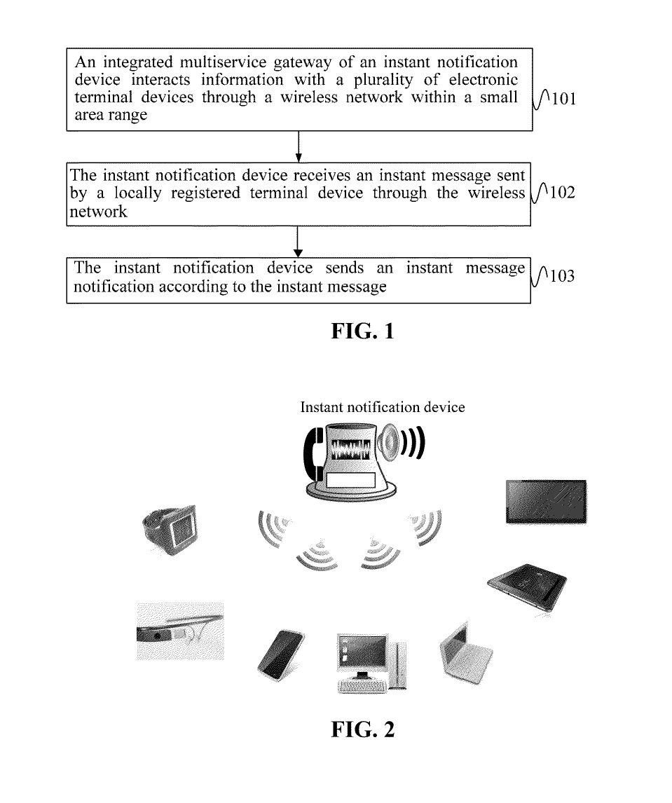

FIG. 1 is a flowchart of an information notification method according to an embodiment of the present disclosure, and an executive body of the method may be a network device arranged in a wireless network, namely, an instant notification device as follows. FIG. 2 is a network architecture diagram of an instant notification system applicable to the method embodiment as shown in FIG. 1. The architecture diagram includes the instant notification device and a plurality of electronic terminal devices, and the instant notification device and the plurality of electronic terminal devices achieve information interaction through the wireless network. As shown in FIG. 1, the above information notification method specifically includes:

S101, an integrated multiservice gateway of the instant notification device interacts information with the plurality of electronic terminal devices through the wireless network within a small area range.

For example, the Integrated Multiservice Gateway (IMSG) arranged in the above instant notification device may communicate with the above other terminal devices through the wireless network, e.g., Digital Living Network Alliance (DLNA), within the small area range (in a home environment). The above terminal devices may be mobile phone terminals, smart televisions, tablet computers, notebook computers, personal computers, GGlass, Gear, etc. Wireless network modules are integrated inside these terminal devices, and these terminal devices have been connected to and registered in the above instant notification device.

S102, the instant notification device receives an instant message sent by a locally registered terminal device through the wireless network. If the terminal device receives an instant incoming call message or an instant short message, receives an instant messaging message by an IM being opened by the terminal device, or receives a new email by an E-mail service being opened, the terminal device will monitor and record the time when receiving these messages or the email. If a terminal has not monitored a processing operation behavior of these messages within a preset time, the terminal device will pack the monitored messages mentioned above into an instant message and send the instant message to the above instant notification device through a built-in information processing software by means of the wireless network. The instant message include a registration identifier, a registration name, message description information and a message receiving time and the like of the terminal device corresponding to the instant message.

S103, the instant notification device sends an instant message notification according to the instant message.

The instant notification device unpacks and analyzes the received instant message, extracts the above specific contents of the instant message and sends the instant message notification in such display manners as voices, texts, icons, indicator lamps and the like, in order to notify the user that the above terminal device receives the current instant message.

According to the information notification method and the instant notification device provided by the present disclosure, receiving the instant message sent by the locally registered terminal device through the wireless network and sends the instant message notification according to the instant message enables users to receive in time instant messages, such as short messages, phone calls, instant messaging information, etc.

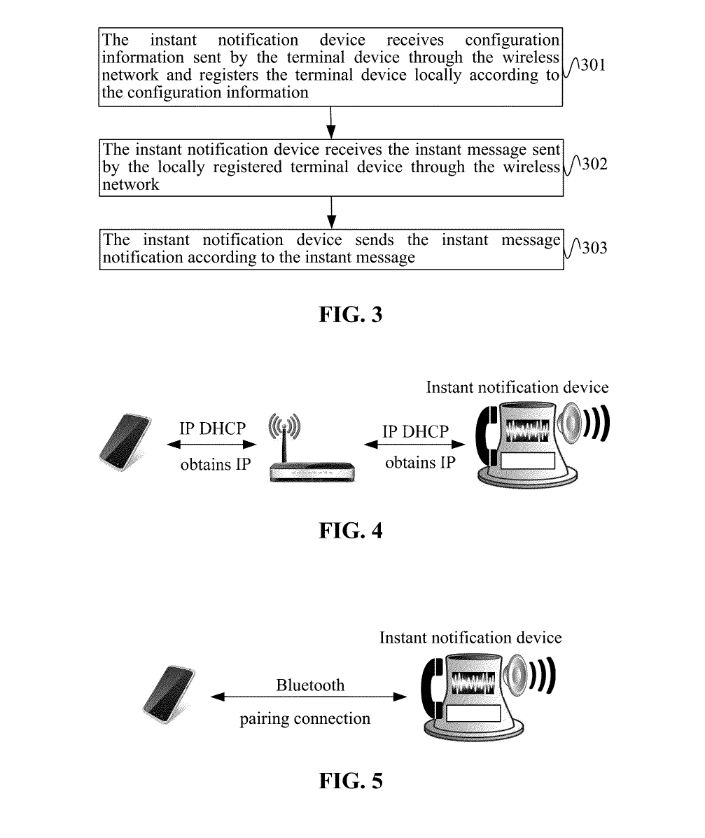

FIG. 3 is a flowchart of an information notification method according to another embodiment of the present disclosure and is a specific implementation mode of the information notification method as shown in FIG. 1. As shown in FIG. 3, the information notification method specifically includes:

S301, an instant notification device receives configuration information sent by a terminal device through a wireless network and registers the terminal device locally according to the configuration information.

Specifically, if performing network connection among the instant notification device and the above each terminal device, several methods as follows may be adopted, including:

as shown in FIG. 4, each terminal device (e.g. a mobile phone terminal) automatically obtains an IP address allocated by the instant notification device to the terminal device in DLNA through Dynamic Host Configuration Protocol (DHCP).

As shown in FIG. 5, the terminal device (e.g. the mobile phone terminal) performs Bluetooth pairing connection with a Bluetooth module in the instant notification device through a built-in Bluetooth module to achieve network connection. In a Bluetooth connection process, a manual matching mode is adopted, or a Near Field Communication (NFC) module is integrated in the instant notification device in advance, and then a matching process between the terminal device and the instant notification device is achieved by the NFC module.

In accordance with the embodiment, a Universal Plug and Play (UPnP) function is integrated into the terminal device and the instant notification device in advance. The instant notification device may find out each terminal device having entered into the DLNA in light of Discover protocol of the UPnP.

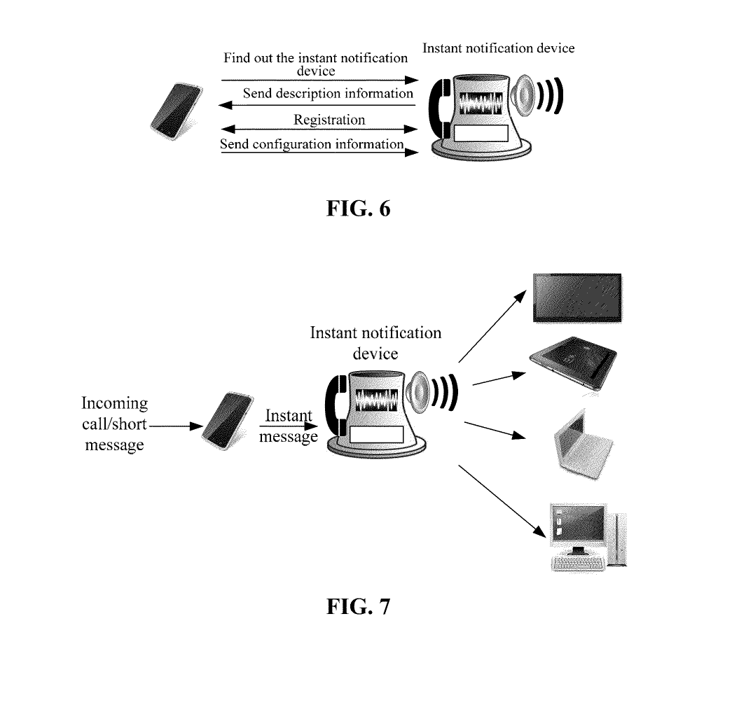

After having entered into the DLNA, the terminal device is required to register on the instant notification device. As shown in FIG. 6 (e.g. the mobile phone terminal), a registration process thereof includes: the terminal device actively finds out the instant notification device through the UPnP function and obtains the device description information of the instant notification device. The terminal device executes a registration flow on the instant notification device according to the device description information and synchronously sends the configuration information thereof after registration to the instant notification device, so as to enable the instant notification device to manage the instant message on the terminal device.

S302, the instant notification device receives the instant message sent by a locally registered terminal device through the wireless network. It is possible to refer to corresponding contents in step 101 as a specific execution process of the step.

Specifically, a software client Application (APP) used for transmitting information to a communication module on the instant notification device may be installed on the above terminal device in advance. The software client APP may monitor whether the terminal device receives the instant message, for example, an instant incoming call message, an instant short message, an instant messaging message corresponding to an IM client, etc. Moreover, the instant message is sent to the instant notification device through the DLNA when satisfying a triggering condition (a time condition or the like), and the instant message may include a registration identifier, a registration name, message description information, a message receiving time and the like of the terminal device corresponding to the instant message.

S303, the instant notification device sends an instant message notification according to the instant message. It is possible to refer to corresponding contents in step 102 as a specific execution process of the step.

Specifically, a voice unit, a text unit, an indicator lamp unit and the like are integrated into the instant notification device. These units may respectively send the above instant message notification in such display manners as a voice broadcast, a text display and an indicator lamp, for example, LED or the like.

For example, as shown in FIG. 7, after receiving the short message or the incoming call, the terminal device (e.g. the mobile phone terminal) organizes the above instant message by the built-in APP client and sends the instant message to the instant notification device through the wireless network. The instant notification device may send the instant message notification through a voice play function, a text display function, an indicator-lamp-display function, etc.

In particular, if the above instant message is the instant incoming call message, the instant notification device may also connect the current call corresponding to the instant incoming call message to a local telephone receiver when sending the instant message notification according to the instant message so as to enable the user to answer the instant incoming call corresponding to the instant incoming call message by answering the telephone receiver. Specifically, a Speaker/Microphone (MIC) function is integrated into the telephone receiver in advance, and the telephone receiver is connected to a registered mobile phone terminal through a Bluetooth protocol. After the mobile phone terminal receives the incoming call, the telephone receiver may be used as a Bluetooth earphone of the mobile phone terminal to achieve a call answering function.

Furthermore, if the instant notification device senses other locally registered terminal devices through the wireless network, when receiving the instant message sent by the locally registered terminal device through the wireless network, the sending, by the instant notification device, an instant message notification according to the instant message further includes:

sending, by the instant notification device, a notification instruction to the other terminal devices (for example, smart televisions, tablet computers, notebook computers, personal computers) through the wireless network so as to indicate the other terminal devices to send the above instant message notification. It is possible to refer to the above notification mode as a specific sending mode, which herein will not be repeated redundantly.

For example, the user is watching TV, or is in front of the computer, and does not hear the call or a short message prompt tone of the mobile phone terminal. At the same time, the instant notification device senses that the above locally registered local television and computer device have been turned on and have been working, and the instant notification device sends the notification instruction to these devices so as to indicate corresponding functional modules built in these devices to send the above instant message notification. These functional modules include the voice unit, the text unit, the indicator lamp unit, etc.

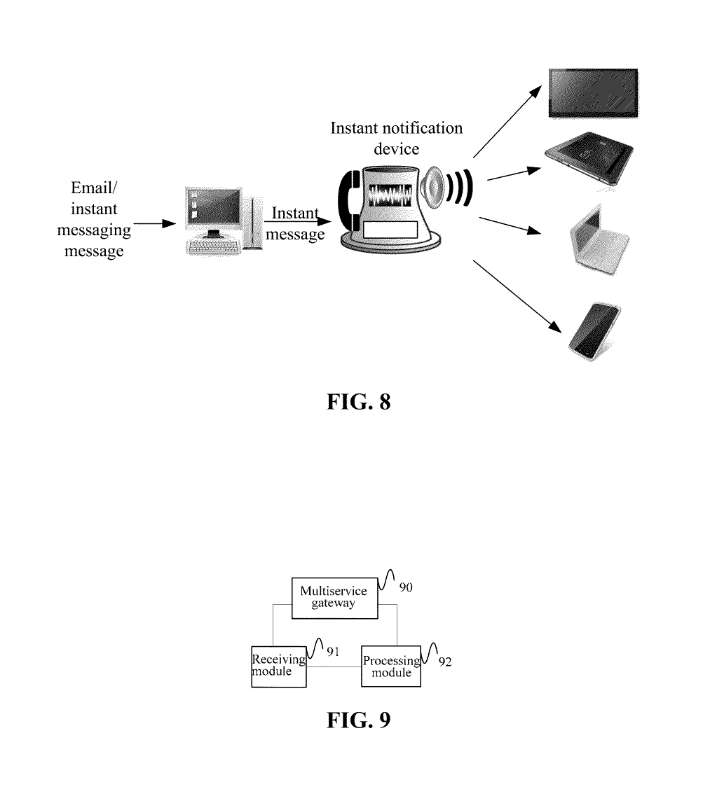

For example, as shown in FIG. 8, after receiving an email or an instant messaging message, the terminal device (e.g. the mobile phone terminal) also organizes the above instant messages by the built-in APP client and sends the instant messages to the instant notification device through the wireless network so as to enable the instant notification device to send the corresponding instant message notification. It is possible to refer to the contents of the method as shown in FIG. 7 as a specific notification process.

According to the information notification method provided by the present disclosure, the instant notification device receives the configuration information sent by the terminal device through the wireless network and registers the terminal device locally according to the configuration information. The instant notification device receives the instant message sent by the locally registered terminal device through the wireless network, and sends the instant message notification according to the instant message, so that the user may receive the instant message in time, such as a short message, a phone call, instant messaging information, etc.

Those of ordinary skill in the art may understand that all or a part of the steps of the above method embodiments may be implemented with a program instructing related hardware. The foregoing program may be stored in a computer readable storage medium. When being executed, the program may include the steps of the above method embodiments. The foregoing storage medium includes a variety of media capable of storing programming codes, such as a ROM, a RAM, a magnetic disk, an optical disk or the like.

FIG. 9 is a schematic diagram of a structure of an instant notification device according to an embodiment of the present disclosure, which may be used for executing the information notification method as shown in FIG. 1. As shown in FIG. 9, the instant notification device specifically includes an integrated multiservice gateway 90, a receiving module 91 and a processing module 92, wherein:

the integrated multiservice gateway 90 is configured to interact information with a plurality of electronic terminal devices through a wireless network within a small area range;

the receiving module 91 is configured to receive an instant message sent by a locally registered terminal device through the wireless network; and

the processing module 92 is configured to send an instant message notification according to the instant message. Furthermore, the category of the instant message sent by the above terminal device through the wireless network includes: an instant incoming call message, an instant short message and an instant messaging message corresponding to an IM client.

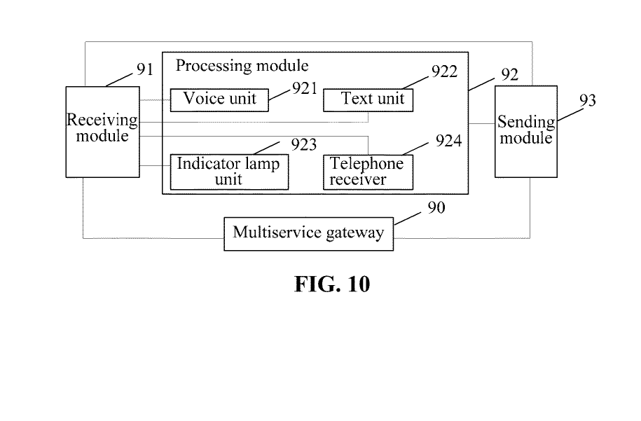

Furthermore, based on the instant notification device as shown in FIG. 9, in the instant notification device as shown in FIG. 10, the above processing module 92 specifically includes: a voice unit 921, a text unit 922 and an indicator lamp unit 923.

The voice unit 921 is configured to send the instant message notification in a voice play manner;

the text unit 922 is configured to send the instant message notification in a text display manner; and

the indicator lamp unit 923 is configured to send the instant message notification in an indicator lamp display manner.

Furthermore, as shown in FIG. 10, the above processing module 92 further includes a telephone receiver 924 configured to, when the instant message is an instant incoming call message, connect to the call function of the current mobile phone terminal corresponding to the instant incoming call message for enabling the user to answer the instant incoming call corresponding to the instant incoming call message by answering the telephone receiver 924.

Furthermore, as shown in FIG. 10, the above instant notification device further includes a sending module 93 configured to send a notification instruction to the other devices through the wireless network so as to indicate the other terminal devices to send the above instant message notification, if the sending module 93 senses other locally registered terminal devices through the wireless network, when the receiving module 91 receives the instant message sent by the locally registered terminal device through the wireless network.

Furthermore, as shown in FIG. 10, the above receiving module 91 is further configured to receive configuration information sent by the terminal device through the wireless network and indicate the processing module 92 to register the terminal device locally according to the configuration information.

The information notification method according to all the above embodiments may be executed by the instant notification device in the embodiment as shown in FIG. 10 and thus the principle of the method thereof will herein not be repeated redundantly.

According to the instant notification device provided by the present disclosure, receiving the configuration information sent by the terminal device through the wireless network, registering the terminal device locally according to the configuration information, receiving the instant message sent by the locally registered terminal device through the wireless network and sending the instant message notification according to the instant message enables the users to receive instant messages in time, such as short messages, phone calls, instant messaging information, etc.

Finally, it should be noted that the above embodiments are merely used for illustrating the technical solutions of the present disclosure, rather than limiting them. Although the present disclosure has been described in detail with reference to the foregoing embodiments, those of ordinary skill in the art should understand that they could still make modifications to the technical solutions recorded in the foregoing embodiments or make equivalent substitutions to a part or all of the technical features therein; and these modifications or substitutions do not make the essence of the corresponding technical solutions depart from the scope of the technical solutions of the embodiments of the present disclosure.

1. An information notification method, comprising:
interacting, by an integrated multiservice gateway of an instant notification device, information with a plurality of electronic terminal devices through a wireless network within a small area range;
receiving, by the instant notification device, an instant message sent by a locally registered terminal device through the wireless network; and
sending, by the instant notification device, an instant message notification according to the instant message.

2. The method of claim 1, wherein a category of the instant message sent by the terminal device through the wireless network comprises: an instant incoming call message, an instant short message and an instant messaging message corresponding to an instant messaging (IM) client.

3. The method of claim 2, wherein if the instant message is the instant incoming call message, the sending, by the instant notification device, an instant message notification according to the instant message further comprises:
connecting, by the instant notification device, a current call corresponding to the instant incoming call message to a local telephone receiver, for enabling a user to answer an instant incoming call corresponding to the instant incoming call message by answering the telephone receiver.

4. The method of claim 1, wherein if the instant notification device senses other locally registered terminal devices through the wireless network, when receiving the instant message sent by the locally registered terminal device through the wireless network, the sending, by the instant notification device, an instant message notification according to the instant message comprises:
sending, by the instant notification device, a notification instruction to the other terminal devices through the wireless network so as to indicate the other terminal devices to send the instant message notification.

5. The method of claim 1, wherein before the receiving, by the instant notification device, an instant message sent by a locally registered terminal device through the wireless network, the method further comprises:
receiving, by the instant notification device, configuration information sent by the terminal device through the wireless network and registering the terminal device locally according to the configuration information.

6. An instant notification device, comprising:
an integrated multiservice gateway, configured to interact information with a plurality of electronic terminal devices through a wireless network within a small area range;
a receiving module, configured to receive an instant message sent by a locally registered terminal device through the wireless network; and
a processing module, configured to send an instant message notification according to the instant message.

7. The instant notification device of claim 6, wherein the category of the instant message sent by the terminal device through the wireless network comprises: an instant incoming call message, an instant short message and an instant messaging message corresponding to an IM client.

8. The instant notification device of claim 7, wherein if the instant message is the instant incoming call message, the processing module further comprises a telephone receiver configured to connect to a call function of a current mobile phone terminal corresponding to the instant incoming call message for enabling a user to answer an instant incoming call corresponding to the instant incoming call message by answering the telephone receiver.

9. The instant notification device of claim 6, further comprising a sending module, wherein the sending module is configured to send a notification instruction to the other devices through the wireless network so as to indicate the other terminal devices to send the instant message notification, if the sending module senses other locally registered terminal devices through the wireless network, when the receiving module receives the instant message sent by the locally registered terminal device through the wireless network.

10. The instant notification device of claim 6, wherein the receiving module is further configured to receive configuration information sent by the terminal device through the wireless network and indicate the processing module to register the terminal device locally according to the configuration information.
